(19) United States
(12) Patent Application Publication
(10) Pub. No.: US 2021/0192456 A1
(43) Pub. Date: Jun. 24, 2021

(54) PROJECT DEVELOPMENT SYSTEM AND METHOD

(71) Applicant: Trudy Stone, Woodland Hills, CA (US)

(72) Inventor: Trudy Stone, Woodland Hills, CA (US)

(21) Appl. No.: 17/189,011

(22) Filed: Mar. 1, 2021

Related U.S. Application Data
(63) Continuation-in-part of application No. 16/821,862, filed on Mar. 17, 2020, now Pat. No. 10,936,754.
(60) Provisional application No. 62/974,798, filed on Dec. 24, 2019.

(51) Int. Cl. G06Q 10/10; G06Q 50/00

(52) U.S. Cl. CPC G06Q 10/103; G06Q 50/01

(57) ABSTRACT

A project development platform that provides online and offline support elements to users to assist with project development of any kind is provided. The system includes a library of development tracks customizable to assist projects of different categories including physical products, services, artwork, software, personal, business, and others. Each development track includes one or more development nodes that deliver support elements specific to the topic(s) of the tracks and nodes. A user may move from one development node to the next within one or more tracks as his/her project is developed. Support elements may include a wide variety of assets ranging from partnerships, mentorships, templates, tutorials, classes, articles, applications, professional feedback, exposure, business development, other types of guidance and support and more. The system may include and/or be integrated with a social network to enable users to interact with one another during the development of each user's respective project. The system is accessed through both online and offline applications including software applications (e.g., mobile applications, etc.), websites, media players, communication services, workshops, classes, and others.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### CROSS-REFERENCE TO RELATED APPLICATIONS

This application is a Continuation-In-Part of U.S. patent application Ser. No. 16/821,862, filed Mar. 17, 2020, the entire contents of which are hereby fully incorporated herein by reference for all purposes.

### FIELD OF THE INVENTION

This invention relates to systems and methods for project development, including an online platform that provides support elements to assist with project development.

### BACKGROUND

Project development typically includes a series of steps taken to move a project from one stage of development to another. Depending on the type of project being developed, the tools required during a project's development cycle may vary widely.

Current project development tools may include classes or tutorials (either online or offline) specifically tailored to a particular topic. For example, software project development tools may include classes or tutorials dedicated to the learning of computer programming, screenplay development tools may include classes on creative writing and plot development, and business plan development tools may include tutorials on developing a plan for a successful business.

However, to be truly successful, a project may require a wide variety of different types of development tools pertaining to topics outside the project's core subject. For example, once a software application has been programmed, the project must be marketed properly to gain awareness and traction in the marketplace. In another example, once a script has been completed, the writer will need to gain knowledge on how to successfully pitch the screenplay to a studio and negotiate a fair contract.

Accordingly, there is a need for a project development platform that offers a wide variety of customized project development tools covering a wide variety of topics.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview framework of a project development system in accordance with exemplary embodiments hereof;

FIG. 2 shows aspects of development tracks and development nodes in accordance with exemplary embodiments hereof;

FIGS. 3-4 shows aspects of development tracks, development nodes and support elements in accordance with exemplary embodiments hereof;

FIGS. 5, 6A and 6B show aspects of graphical user interfaces (GUIs) in accordance with exemplary embodiments hereof;

FIG. 7 shows aspects of a project development system in accordance with exemplary embodiments hereof; and

FIG. 8 depicts aspects of computing and computer devices in accordance with exemplary embodiments hereof.

### DETAILED DESCRIPTION OF EXEMPLARY EMBODIMENTS

As used herein, unless used otherwise, the following terms and abbreviations have the following meanings:

A social network is a dedicated website system or other application which enables users to communicate with each other by posting information, comments, messages, images, etc.

Social contacts are nodes within a social graph (representing an individual or organization) to which another node is socially connected (e.g., through a social network). When individuals and/or organizations are connected through a social network, the individuals and/or organizations may communicate with one another through the social network.

In general, and according to exemplary embodiments hereof, the project development system 10 includes a system and method of providing one or more services, products, guides, templates, tutorials, contacts, mentorships, support groups, and/or other elements (herein referred to as “support elements” or simply as “support”) to a user to support the user in developing a project. The system 10 also may provide visibility and increased awareness of the user and/or the project under development. The project under development may include any type of project, including, without limitation, a product, service, and/or any other type of item and/or activity. In some embodiments, the system 10 may provide the support to the user via online platform(s) or channels, while in other embodiments, the system 10 may provide the support to the user through offline channel(s), and/or through any combination of online and/or offline platforms and/or channels.

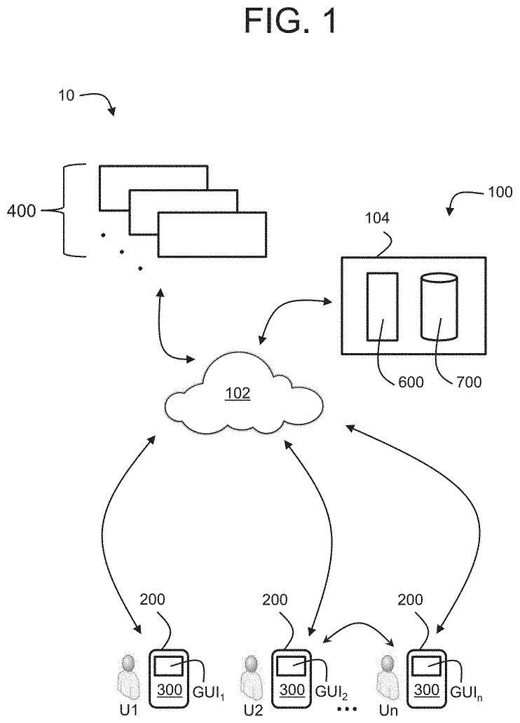

FIG. 1 shows an overview of an exemplary framework for a project development system 10 according to exemplary embodiments hereof. As shown, the project development system 10 includes a cloud platform 100 (also referred to as a backend system, backend, or controller) accessible through a network 102 such as the Internet, LAN, WAN, wireless communication systems, cellular communication systems, telephony or other types of communication systems or protocols. As will be described in other sections, the backend system 100 includes one or more servers 104 including one or more applications 600 and one or more databases 700. The one or more software systems 106 may include operating systems, system software, web server software, social networking software, communication software, software applications, scripts, firmware, other types of software systems and any combinations thereof.

The system 10 is accessed by multiple users U0, U1, U2 . . . Un (e.g., via the network 102) using one or more applications 300 (e.g., a mobile application or “app”, a browser, and/or other type(s) of applications) running on one or more computing devices 200 (e.g., client devices such as smart phones, tablet computers, laptop computers, desktop computers, mobile media players, etc.). The system 10 also may interface with various external entities and/or systems 400 such as mentors, consultants, representatives, agents, teachers, professors, professionals, businesses, manufacturers, factories, organizations, associations, government offices, other types of individuals and/or entities, and any combinations thereof.

For the purposes of this specification, a user Un may include an individual, a group of individuals, partners, a business, an association, and/or any other type of entity wishing to develop a project. When more than one users Un are working together while developing a project, the users Un may be acquainted with one another prior to their interaction with the system 10, or not. In some embodiments, the system 10 may introduce the users Un to one another while providing support for the development of the project. For example, the system 10 may introduce a user Un to a consultant with specific expertise for the benefit of the project under development. This will be described in detail in other sections.

In some embodiments, the system 10 may include one or more social networks such as disclosed by U.S. patent application Ser. No. 16/821,862, filed Mar. 17, 2020, the entire contents of which are hereby fully incorporated herein by reference for all purposes. In this way, multiple users Un may interact with one another (with his/her social contacts) through the social network(s) as they interact with the system 10. However, this may not be necessary and other types of online platforms may be used.

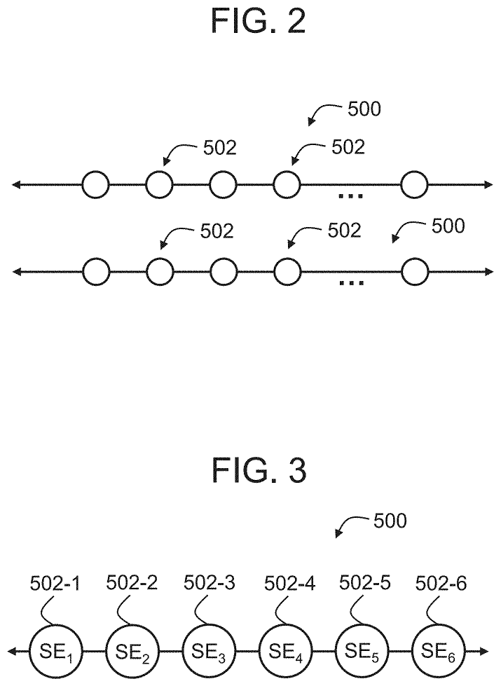

In some embodiments as shown in FIG. 2, the system 10 includes one or more development tracks 500, with each development track 500 including one or more development nodes 502. Each development track 500 may pertain to a particular topic or category of development (e.g., product design, manufacturing, screenplay development, software development, etc.), and each development node 502 may pertain to sub-topics or sub-categories within the topics and/or categories of its associated track 500.

As will be described in detail in other sections, a project P may move through a development track 500 from one node 502 to another node 502 as the project P is developed (e.g., as the user Un takes user actions under the guidance of the system 10), with each node 502 providing specific developmental support elements SE to the project P along the way. In some embodiments, a project P may pass through one track 500 at a time, while in other embodiments, a project P may pass through two or more tracks 500 simultaneously and/or in parallel. Alternatively, a project P may pass through a portion of one or more tracks 500 and/or may be presented with one or more individual nodes 502 that may not necessarily be within the same track 500.

As mentioned above, each development node 502 may provide one or more developmental support elements SE to the project P. In one example as shown in FIG. 3, a development track 500 pertaining to screenplay development may include a first node 502-1 that provides a support element SE₁ pertaining to plot development, a second node 502-1 that provides a support element SE₂ pertaining to character development, a third node 502-3 that provides a support element SE₃ pertaining to overcoming writer's block, a fourth node 502-4 that provides a support element SE₄ pertaining to editing, a fifth node 502-5 that provides a support element SE₅ pertaining to pitching the screenplay to studios, a sixth node 502-6 pertaining to contract negotiations, and/or other nodes 502 that provide other support elements SE₆ pertaining to other topics or categories relevant to the development of screenplays. It is understood that this example is meant for demonstration and is non-limiting.

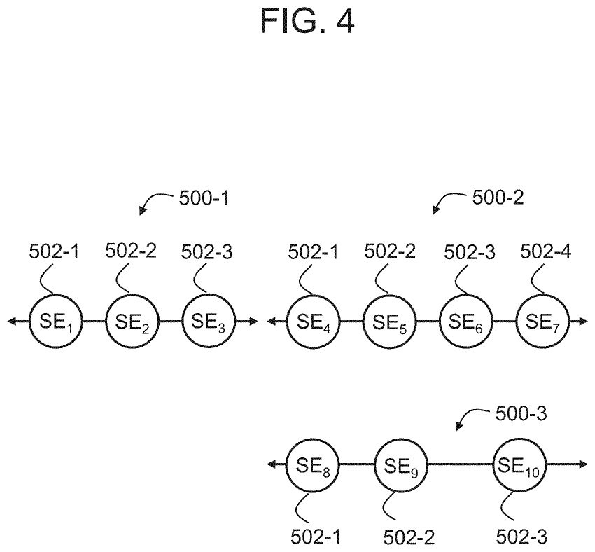

In another example as shown in FIG. 4, a project P that includes the development of a physical product may pass through a first development track 500 (e.g., a product design track 500-1), a second development track 500 (e.g., a product production track 500-2), and a third development track 500 (e.g., a sales and marketing track 500-3). In this way, the system 10 may provide support to the product development of the product P from the design phase to the production phase and through the sales and marketing phase. In this example, the project P may pass through the first and second tracks 500-1, 500-2 sequentially (because production may typically follow product design), and then pass through the second and third tracks 500-2, 500-3 in parallel (because sales and marketing may be planned while manufacturing is established).

Expanding on this example, the first track 500-1 (product design) may include a first node 502-1 providing support elements SE₁ pertaining to ideation wherein the various elements of the product may be imagined and formulated, a second node 502-3 providing support elements SE₂ pertaining to creating computer aided design (CAD) drawings of the product, and a third node 502-3 providing support elements SE₃ pertaining to prototyping the product (e.g., 3D printing). The second track 500-2 may include a first node 502-1 providing support elements SE₄ pertaining to the understanding of different types of applicable manufacturing processes (e.g., injection molding), a second node 502-2 providing support elements SE₅ pertaining to contacting and/or vetting potential manufacturers, a third node 502-3 providing support elements SE₆ pertaining to creating the manufacturing tools necessary for production (e.g., injection molds), and a fourth node 502-4 providing support elements SE₇ pertaining to the setting up of a production line within a factory. The third track 500-3 may include a first node 502-1 providing support elements SE₈ pertaining to market research, a second node 502-2 providing support elements SE₉ pertaining to analyzing the competitive landscape for the product, and a third node 502-3 providing support elements SE₁₀ pertaining to vetting potential distributors and sales agents for the product. It is understood that this example is meant for demonstration and that the system 10 may include tracks 500 and nodes 502 that provide any type of relevant support elements SE to a project P, and that the system 10 is not limited in any way by the type of project supported and/or the type of support to the project P (and its associated user Un) that the system 10 may provide.

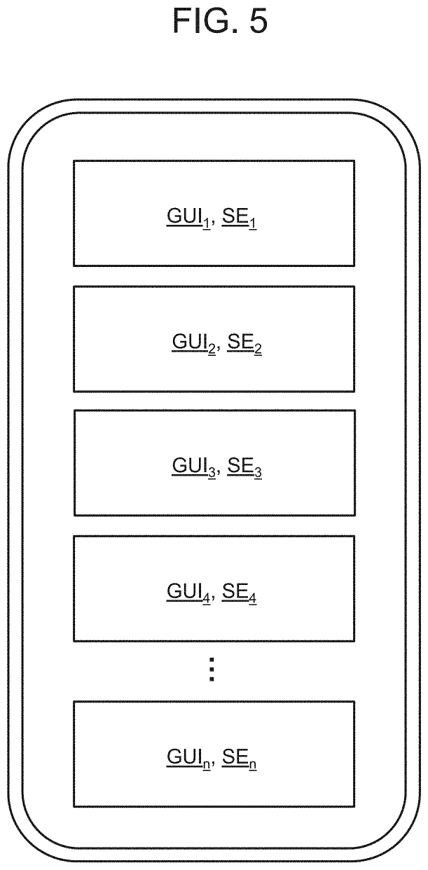

In some embodiments as shown in FIG. 5, the system 10 provides one or more graphical user interfaces GUIₙ to a user Un (e.g., via an application 300 running on the user's device 200) while the user Un interfaces with the system 10. In some embodiments, each GUI may depend on the current track 500 and/or node 502 at which the project P resides as well as the one or more support elements SE pertinent to the specific topic or category of the track 500 and/or the node 502. For example, as shown in FIG. 5, GUI, may provide elements required to deliver the support elements SE₁, GUI₂ may provide elements required to deliver the support elements SE₂, GUI₃ may provide elements required to deliver the support elements SE₃, GUI₄ may provide elements required to deliver the support elements SE₄, and GUIₙ may provide elements required to deliver the support elements SEₙ. While the GUIs and support elements SE shown in FIG. 5 are shown as being provided simultaneously on a single display, it is understood that some GUIs and support elements SE may be provided individually while other GUIs and support elements SE may be provided together, in combination and/or simultaneously. In addition, while FIG. 5 shows the GUIs and the support elements SE being provided on the user's smartphone device 200, it is understood that the GUIs and/or support elements SE may be provided on any device 200 or on any number of devices 200 as appropriate for the GUIs and/or the support elements SE. In other embodiments, other types of GUIs may be provided that may not necessarily depend on the track 500 or the node 502.

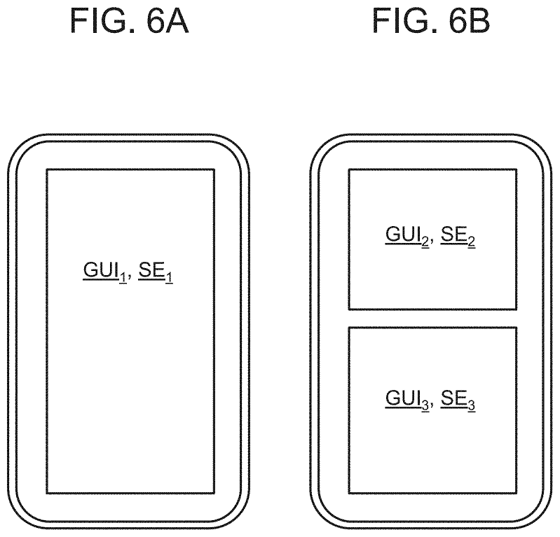

As shown in FIGS. 6A and 6B, expanding on the example above regarding the development of a physical product, a first GUI, may provide product design tools SE₁ as the project P passes through the first track 500-1 (the product design track 500). This GUI₁ may be displayed on a device 200 as shown in FIG. 6A. A second GUI₂ may then provide manufacturing guidance and/or contacts SE₂ as the project P passes through the second track 500-2 (the manufacturing track 500), and a third GUI₃ may provide sales and marketing guidance as the project P passes through the third track 500-3 (the sales and marketing track 500). In this example, the first GUI₁ and corresponding support elements SE₁ are provided independently, while the second GUI₂ (and related support elements SE₂) and the third GM (and related support elements SE₃) are provided together since in this example the second and third tracks 500-2, 500-3 may be performed in parallel. However, it is understood that this example is meant for demonstration and that any GUIs and/or related support elements SE may be provided either individually, in parallel, or in any combinations thereof.

In some embodiments, the support elements SE may include tools integrated with the application 300 and the GUIs such that a user Un may interface with the tools SE directly via the GUIs on his/her device 200. In other embodiments, the support elements SE may include separate applications that may be accessed or otherwise interacted with via separate applications, websites, software downloads or packages, etc. In these cases, a GUI may facilitate the downloading or otherwise provide access to the separate tools, may direct the user Un to the separate applications for usage, and/or may generally provide information to the user regarding the tools. Application programming interfaces (APIs) and/or software development kits (SDKs) may be provided as required.

In some embodiments, the support elements SE (e.g., the tools) may include one or more software applications integrated into or generally provided by a system GUI. For example, the support elements SE may include, without limitation, word processors, illustration tools, computer aided design (CAD) tools, spreadsheets, audio recording tools, audio editing tools, audio mixing tools, audio production tools, video recording tools, video editing tools, video mixing tools, video production tools, animation tools, wizards on any topic, other types of software tools and any combinations thereof. It is understood that the system 10 may facilitate the provision of any type of software application that may be beneficial to the development of a project P, and that the scope of the system 10 is not limited in any way by the type of item that it may provide as a support element SE.

In some embodiments, the support elements SE may include physical products or items that may be needed for the development of a project P. For example, a project that involves restoring a vintage automobile may require specific tools and/or parts for the restoration, and the system 10 may facilitate the provision of the tools or parts. It is understood that the system 10 may facilitate the provision of any type of physical item that may benefit the development of a project P, and that the scope of the system 10 is not limited in any way by the type of item that the system 10 may provide as a support element SE.

In some embodiments, the support elements SE may include services provided by other individuals and/or entities (e.g., external entities and/or systems 400). For example, the services may include, without limitation, consulting, training, teaching, mentoring, advising, contracted services, accounting, performing an action that benefits the development of the project P or otherwise moves the project's development forward, providing expertise, providing any other type of service and any combinations thereof. For example, expanding on the example provided above regarding the restoration of a vintage automobile, some of the automobile's parts may be required to be sent to a specialty service shop that possess specialty tools required for the servicing of the parts (e.g., to re-chrome a vintage bumper), and the system 10 may put the user Un in touch with the specialty shop and facilitate the servicing of the parts.

In some embodiments, the support elements SE may include digital assets such as, without limitation, online guides, templates, tutorials, classes, videos, checklists, schedules, books, audio books, blogs, research papers, articles, do-it-yourself (DIY) materials, other types of digital assets and any combinations thereof.

In some embodiments, the support elements SE may include connecting the user Un to one or more contacts that may benefit the development of a project P. These contacts may include other users Un of the system 10 and/or contacts that may not necessarily be users of the system 10 (e.g., personal contacts of the user Un). For example, the system 10 may connect a first user U1 with one or more other users Un with similar interests. In another example, the system 10 may connect a user Un with mentors, potential investors, support groups, discussion groups, forums, social media networks, consultants, associations, organizations, businesses, other types of contacts and any combinations thereof.

In any of the embodiments, the support elements SE may include one or more stipulated user actions UA that the user Un may be advised and/or required to take before a project P may move from one node 502 to the next node 502. For example, a user action UA may include viewing a video (e.g., live and/or recorded), reading a document, listening to audio (e.g., live and/or recorded), taking a class, making or otherwise obtaining an item, downloading a software application, using a software application, drafting a document, taking a test, making a contact, meeting with a consultant, partnering with another user Un, partnering with an entity, any other type of user action UA, and any combinations thereof.

In some embodiments, the system 10 may promote the user's project P to other users Un of the system 10 (e.g., within an integrated social network) and/or to other individuals or entities outside the system 10. For example, the system 10 may display elements of a user's project P (e.g., an executive summary, a pitch deck, images of a prototype, etc.) to other users Un of the system 10 to garner their interests in providing support to the user Un and the project P. This may increase the visibility of the project P within and outside of the system 10.

Additional embodiments and details of the system 10 will be described by way of several detailed examples. The examples provided below are chosen to illustrate various embodiments and implementations of the system 10, and those of ordinary skill in the art will appreciate and understand, upon reading this description, that the examples are not limiting and that the system 10 may be used in different ways. It is also understood that details of different embodiments described in different examples may be combined in any way to form additional embodiments that are all within the scope of the system 10.

In a first example, a user Un may wish to utilize the system 10 to develop a project P. In this example, the user Un may have only an initial concept of the project P and may wish to begin the development at the beginning stages and progress from there.

In some embodiments, the system 10 may provide a questionnaire, and/or a wizard (or other type of method of acquiring information) requesting information from the user Un regarding the project P. The requested information may include the type of project (e.g., software, physical product, service, etc.), details regarding specific elements of the project P, the user's experience in the field of the project P, what type of help and/or support the user Un is asking for (e.g., specific expertise, financial, emotional support, etc.), the timeline that the user Un has defined for the project P, and any other details regarding the project P and/or the user Un that may assist the system 10 providing support to the user Un and the project P.

In some embodiments, the system 10 may utilize the information provided by the user Un to identify and/or create specific developmental tracks 500 and/or developmental nodes 502.

In some embodiments, for users Un wishing to find a project to develop, the system 10 may provide a questionnaire seeking to discover and/or provide insight to the user's interests and passions, and may utilize the information received to recommend one or more projects for development. The user Un may then choose a project P (or provide his/her own), and may then utilize the system 10 to help develop the project P.

In some embodiments, the system 10 may include predefined tracks 500 and associated nodes 502 for various types of projects P, while in other embodiments, the system 10 may create customized tracks 500 and/or nodes 502 specific to a project P.

In one example, the user's project P may include the development of a mobile application, and the system 10 may identify a software development track 500-1, a track 500-2 assisting in raising capital, and a sales and marketing track 500-3.

In some embodiments, the system 10 may provide to the user Un a summary of the tracks 500-1, 500-2, 500-3 with information regarding the tracks 500 and the nodes 502 included in each track 500 so that the user Un may understand the proposed project development flow. In some embodiments, the user Un may accept and/or decline any of the tracks 500 and/or nodes 502, and/or may request that the tracks 500 and/or nodes 502 be modified to better meet his/her expectations and needs. In this case, the system 10 may alter (or customize) the proposed tracks 500 accordingly and provide a new summary to the user Un for review.

Once one or more tracks 500 are accepted, the system 10 may provide additional information regarding the nodes 502 that may be included in each track 500. Once the nodes 502 are accepted, the system 10 may begin providing support elements SE to the user Un. Note that it may not be required that the user Un accept each track 500 and/or each node 502, and in some embodiments, the system 10 may simply provide the tracks 500, nodes 502 and associated support elements SE to the user Un directly.

Expanding on the mobile application development project P, the software development track 500-1 may include a first node 502-1 that provides an overview of mobile application development. During the launch of this node 502-1, the system may provide an associated GUN that may launch a media player that provides the overview (the support element SE1). After the user Un has completed the tutorial at node 502-1, he/she may move to a second node 502-2 and the system 10 may provide the user Un with a new GUI2 and a new support element SE2 including a step-by-step tutorial on how to program a mobile application. The second support element SE2 may be provided entirely through the second GUI2 or may be provide through other means such as downloads, links, websites, other applications, widgets, cloud files, emails, texts, phone calls, elements provided to other devices such as tablet computers, laptops, desktop computers, by other means and by any combinations thereof.

At this stage in the example, a user Un may decide that learning to develop software necessary for a mobile application may be beyond his/her interest level, and as such, may instead be interested in being connected with a software programmer for assistance. In this case, the user Un may opt to leave the second node 502-2 (e.g., before completing it) and jump to the third node 502-3 that may provide the connection to a software programmer. Upon launching the third node 502-3, the system 10 may provide a third GUI₃ that may provide support elements SE₃ including means to connect with one or more software programmers to assist with the programming of the mobile application.

After the user Un has completed the software development track 500-1, or in parallel to the software track 500-1, the user Un may launch and be provided with the raising capital track 500-2 and/or the sales and marketing track 500-3.

In one example, when the user Un enters the capital raise track 500-2, the system 10 may present a first node 502-1 for this track comprising guidance (support element SE₁) on developing a business plan. The support element SE1 may include tutorials, templates, example business plans, and other types of tools and/or guidance on business plan development. The system 10 may provide a GUI1 and/or other methods to provide this support element SE1. Once the user Un as experienced the first node 502-1, he/she may move to the second node 502-2 that may include providing the business plan (e.g., the plan developed in the first node 502-1) to experts and/or mentors who may provide feedback and comments. This node 502-2 may launch a GUI2 that may provide the contact information to the experts and/or a chat or video call application that may be used to interface with (e.g., conference calls) with the contacts provided.

Once the user Un has received the feedback from the contacts provided in the second node 502-1 and implemented them as seen fit, the user Un may move to the third node 502-3 that may pitch the completed business plan to angel investors, venture capitalists, crowd funding platforms, other types of investors and any combinations thereof. In this way, the business plan may receive increased visibility thereby improving the project's chances of receiving funding. The system 10 also may assist in the investment negotiations (e.g., through mentors, tutorials, etc.) and the project's final capitalization.

In another example, a user Un may develop the mobile application on his/her own and not need funding, and accordingly may skip the first and second tracks 500-1, 500-2 and may proceed directly to the third track 500-3 (the sales and marketing track). In this example, the user Un may open the third track 500-3 and the system 10 may present him/her with one or more nodes 502 pertaining to sales and marketing that may provide the support elements SE necessary for a successful product launch, sales growth, and overall business development.

In some embodiments, the system 10 may include a library of development tracks 500 and/or development nodes 502 and may simply present the library of tracks 500 and/or nodes 502 for the user Un to pick and choose from. In this way, the user Un may create his/her own set of tracks 500 and nodes 502. In some embodiments, the user Un may alter and/or amend any selection of tracks 500 and/or nodes 502 during development as he/she may see fit. In this way, the project development may be fluid and may be customized in situ during the development cycle.

In some embodiments, when one or more users Un are working together on the development of a project P, the system 10 may provide specific tracks 500 and nodes 502 to the first user Un to experience and/or complete, and specific tracks 500 and nodes 502 to a second user Un to experience and/or complete. In some embodiments, one or more tracks 500 and/or nodes 502 provided to the first user Un may differ from one or more tracks 500 or nodes provided to the second user Un so that the first and second users Un may work on different aspects of the project in parallel. In other embodiments, the first and second users Un may be presented with the same tracks 500 and/or nodes 502 when it may be beneficial for both users Un to experience or otherwise complete the tracks 500 and/or nodes 502.

In some embodiments, the system 10 may implement a scheduler for the user Un to help the user Un keep on track with his/her project development. The scheduler may include daily to-do lists, calendared events, deadlines, motivational messages (e.g., sent to the user Un daily), other types of scheduling activities and any combinations thereof.

In any embodiments herein, any node 502 may be duplicated in any track 500 as appropriate.

In any embodiments herein, any support element SE may be provided for free, for a monetary charge, as a barter, using any other type of arrangement and as any combinations thereof.

System Structure

FIG. 10 shows aspects of an exemplary project development system 10 of FIG. 1. As shown, the system 10 and backend system 100 comprises various internal applications 600 and one or more databases 700, described in greater detail below. The internal applications 600 may generally interact with the one or more databases 700 and the data stored therein.

The database(s) 700 may comprise one or more separate or integrated databases, at least some of which may be distributed. The database(s) 700 may be implemented in any manner, and, when made up of more than one database, the various databases need not all be implemented in the same way. It should be appreciated that the system is not limited by the nature or location of database(s) 700 or by the manner in which they are implemented.

Each of the internal applications 600 may provide one or more services via an appropriate interface. Although shown as separate applications 600 for the sake of this description, it is appreciated that some or all of the various applications 600 may be combined. The various applications 600 may be implemented in any manner and need not all be implemented in the same way (e.g., using the same software languages, interfaces, or protocols).

In some embodiments, the applications 600 may include one or more of the following applications 600:
1. Development Track Execution application(s) 602. This application 602 provides all of the activities associated with developing, launching, executing, maintaining, organizing, scheduling, delivering, and otherwise providing the development track(s) 500 to the users Un.
2. Development Node Execution application(s) 604. This application 604 provides all of the activities associated with developing, launching, executing, maintaining, organizing, scheduling, delivering, and otherwise providing the development node(s) 502 and associated support elements SE to the users Un.
3. Data input application(s) 606. This application may receive any type of input data from any user Un, application, system and/or source such as the application 200, the mobile device 300, external systems 400 (e.g., mentors outside the system 10), other sources and any combination thereof.
4. Data output applications(s) 608. This application may output any type of output data to any application, system and/or source such as the application 200, the mobile device 300, external systems 400, any other source and any combination thereof.
5. GUI Execution application(s) 610. This application 602 provides all of the activities associated with launching, executing, maintaining, organizing, delivering, and otherwise providing the GUIs to the users Un.
6. Social Network application(s) 612. This application provides all of the activities associated with developing, launching, executing, maintaining, organizing, delivering, and otherwise providing a social network platform to the users Un.

The applications 600 also may include other applications and/or auxiliary applications (not shown). Those of ordinary skill in the art will appreciate and understand, upon reading this description, that the above list of applications is meant for demonstration and that the system 10 may include other applications that may be necessary for the system 10 to generally perform its functionalities as described in this specification. In addition, as should be appreciated, embodiments or implementations of the system 10 need not include all of the applications listed, and that some or all of the applications may be optional. It is also understood that the scope of the system 10 is not limited in any way by the applications that it may include.

In some embodiments, the database(s) 700 may include one or more of the following databases:
1. Project Details database(s) 702. This database may store any data and/or other types of information related to and/or required by projects P under development. For example, the database 702 may include information provided by the user Un developing a respective project P, information provided by other users Un and/or other entities pertaining to a particular project P, and any other information pertaining to one or more projects P.
2. Development Track database(s) 704. This database may store any data, information, assets, applications, and/or other types of information and/or systems related to and/or required by any development track 500.
3. Development Node database(s) 706. This database may store any data, information, assets, applications, and/or other types of information and/or systems related to and/or required by any development node 502 including any associated support elements SE and/or elements.
4. GUI database(s) 708. This database may store any data, information, assets, applications, and/or other types of information and/or systems related to and/or required by any GUIₙ.
5. Social Network database(s) 710. This database may store any data, information, assets, applications, and/or other types of information and/or systems related to and/or required by any social network integrated with or otherwise utilized by the system 10.
6. External Systems database(s) 712. This database may store any information, details and/or data pertaining to any external system 400 (e.g., contact information for external mentors, etc.).

It is understood that the above list of databases is meant for demonstration and that the system 10 may include some or all of the databases, and also may include additional databases as required. It is also understood that the scope of the system 10 is not limited in any way by the databases that it may include.

Various applications 600 and databases 700 in project development system 10 may be accessible via interface(s) 106. These interfaces 106 may be provided in the form of APIs or the like and made accessible to users Un via one or more gateways and interfaces 108 (e.g., via a web-based application 200 and/or a mobile application 200 running on a user's device 300).

It is understood that any aspect and/or element of any of the embodiments described herein or otherwise may be combined in any way to form new embodiments easily understood by a person of ordinary skill in the art and all within the scope of the system 10. Those of ordinary skill in the art will appreciate and understand, upon reading this description, that embodiments hereof may provide different and/or other advantages, and that not all embodiments or implementations need have all advantages.

Computing

The services, mechanisms, operations, and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

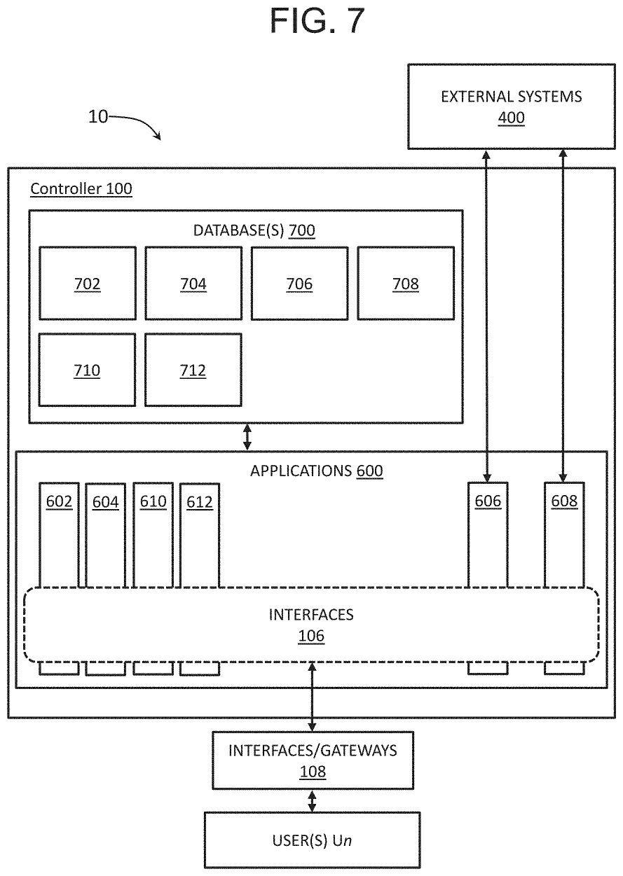

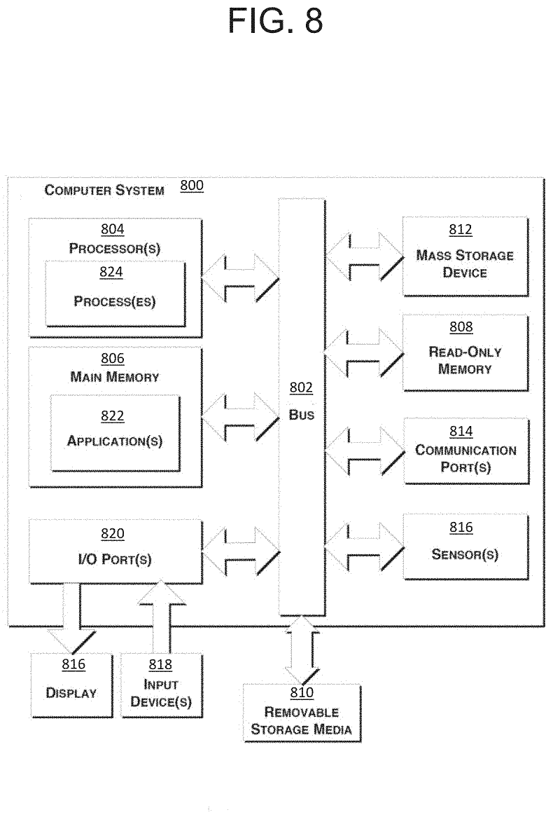

FIG. 7 is a schematic diagram of a computer system 800 upon which embodiments of the present disclosure may be implemented and carried out.

According to the present example, the computer system 800 includes a bus 802 (i.e., interconnect), one or more processors 804, one or more communications ports 814, a main memory 806, removable storage media 810, read-only memory 808, and a mass storage 812. Communication port(s) 814 may be connected to one or more networks by way of which the computer system 800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 804 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 814 can be any of an RS-232 port for use with a modem-based dial-up connection, a 10/100 Ethernet port, a Gigabit port using copper or fiber, or a USB port, and the like. Communications port(s) 814 may be chosen depending on a network such as a Local Area Network (LAN), a Wide Area Network (WAN), a CDN, or any network to which the computer system 800 connects. The computer system 800 may be in communication with peripheral devices (e.g., display screen 816, input device(s) 818) via Input/Output (I/O) port 820. Some or all of the peripheral devices may be integrated into the computer system 800, and the input device(s) 818 may be integrated into the display screen 816 (e.g., in the case of a touch screen).

Main memory 806 can be Random Access Memory (RAM), or any other dynamic storage device(s) commonly known in the art. Read-only memory 808 can be any static storage device(s) such as Programmable Read-Only Memory (PROM) chips for storing static information such as instructions for processor(s) 804. Mass storage 812 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 802 communicatively couples processor(s) 804 with the other memory, storage and communications blocks. Bus 802 can be a PCI/PCI-X, SCSI, a Universal Serial Bus (USB) based system bus (or other) depending on the storage devices used, and the like. Removable storage media 810 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor, or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards, or protocols; and/or (iv) encrypted in any of a variety of ways well known in the art.

A computer-readable medium can store (in any appropriate format) those program elements that are appropriate to perform the methods.

As shown, main memory 806 is encoded with application(s) 822 that support(s) the functionality as discussed herein (an application 822 may be an application that provides some or all of the functionality of one or more of the mechanisms described herein). Application(s) 822 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 804 accesses main memory 806 via the use of bus 802 in order to launch, run, execute, interpret or otherwise perform the logic instructions of the application(s) 822. Execution of application(s) 822 produces processing functionality of the service(s) or mechanism(s) related to the application(s). In other words, the process(es) 824 represents one or more portions of the application(s) 822 performing within or upon the processor(s) 804 in the computer system 800.

It should be noted that, in addition to the process(es) 824 that carries (carry) out operations as discussed herein, other embodiments herein include the application 822 itself (i.e., the unexecuted or non-performing logic instructions and/or data). The application 822 may be stored on a computer readable medium (e.g., a repository) such as a disk or in an optical medium. According to other embodiments, the application 822 can also be stored in a memory type system such as in firmware, read only memory (ROM), or, as in this example, as executable code within the main memory 806 (e.g., within Random Access Memory or RAM). For example, application 822 may also be stored in removable storage media 810, read-only memory 808, and/or mass storage device 812.

Those skilled in the art will understand that the computer system 800 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A computer-implemented method comprising:
(A) by one or more computer systems, receiving from a first user first information relating to a first project development, the first information defining a first stage of development of the first project development;
(B) by one or more computer systems, determining a first developmental node corresponding to the first stage of development;
(C) by one or more computer systems, determining one or more first developmental support elements associated with the first development node, the one or more first development support elements including information relating to a first user action to be performed by the first user;
(D) by one or more computer systems, providing to the first user the one or more first developmental support elements determined in (C);
(E) by one or more computer systems, receiving an indication of the first user action by the first user;
(F) by one or more computer systems, when the indication in (E) is received:
(G) determining a second stage of development of the first project development; and
(H) determining a second developmental node corresponding to the second stage of development.

2. The method of claim 1 further comprising:
(I) by one or more computer systems, determining one or more second developmental support elements associated with the second development node, the one or more second development support elements including information relating to a second user action to be performed by the first user;
(J) by one or more computer systems, providing to the first user the one or more second developmental support elements determined in (I);
(K) by one or more computer systems, receiving an indication of the second user action by the first user;
(L) by one or more computer systems, when the indication in (K) is received:
(M) determining a third stage of development of the first project development; and
(N) determining a third developmental node corresponding to the third stage of development.

3. The method of claim 2 further comprising:
(O) by one or more computer systems, providing to the first user the one or more third developmental support elements determined in (N).

4. The method of claim 1 wherein the first user is a user of a social-networking system, the social-networking system comprising a graph that comprises a plurality of nodes and edges connecting the nodes, at least one node in the graph corresponding to the first user, and at least one node in the graph corresponding to a second user of the social-networking system.

5. The method of claim 1 wherein the one or more first development support elements include at least one of a software application, a physical product, a service, a digital asset, and a personal contact.

6. The method of claim 2 wherein the one or more second development support elements include at least one of a software application, a physical product, a service, a digital asset, and a personal contact.

7. The method of claim 1 further comprising:
(B)(1) by one or more computer systems, indicating that the first project development is associated to the first developmental node.

8. The method of claim 1 further comprising:
(H)(1) by one or more computer systems, indicating that the first project development is associated to the second developmental node.

9. The method of claim 2 further comprising:
(O) indicating that the first project development is associated to the third developmental node.

10. The method of claim 1 wherein the providing to the first user the one or more first developmental support elements in (D) includes providing at least a portion of the one or more first developmental support elements via a first graphical user interface.

11. The method of claim 2 wherein the providing to the first user the one or more second developmental support elements in (J) includes providing at least a portion of the one or more second developmental support elements via a second graphical user interface.

12. The method of claim 3 wherein the providing to the first user the one or more third developmental support elements in (O) includes providing at least a portion of the one or more third developmental support elements via a third graphical user interface.

13. The method of claim 1 wherein the first user action includes at least one of reading a document, viewing a video, listening to audio, taking a class, using a software application, making a contact, partnering with a second user, and meeting with an entity.

14. A computer-implemented method comprising:
(A) by one or more computer systems, receiving from a first user first information relating to a first project development, the first information defining a first stage of development of the first project development and a desired project development outcome;
(B) by one or more computer systems, determining a first developmental node corresponding to the first stage of development;
(C) by one or more computer systems, determining one or more first developmental support elements associated with the first development node, the one or more first development support elements including information relating to a first user action to be performed by the first user;
(D) by one or more computer systems, providing to the first user the one or more first developmental support elements determined in (C);
(E) by one or more computer systems, receiving an indication of the first user action by the first user;
(F) by one or more computer systems, when the indication in (E) is received:
(G) determining a second stage of development corresponding to the desired project development outcome; and
(H) determining a second developmental node corresponding to the second stage of development.

15. The method of claim 14 further comprising:
(I) by one or more computer systems, determining one or more second developmental support elements associated with the second development node, the one or more second development support elements including information relating to a second user action to be performed by the first user;
(J) by one or more computer systems, providing to the first user the one or more second developmental support elements determined in (I);
(K) by one or more computer systems, receiving an indication of the second user action by the first user;
(L) by one or more computer systems, when the indication in (K) is received:
(M) associating the first project development with the desired project development outcome.

16. The method of claim 14 wherein the first user is a user of a social-networking system, the social-networking system comprising a graph that comprises a plurality of nodes and edges connecting the nodes, at least one node in the graph corresponding to the first user, and at least one node in the graph corresponding to a second user of the social-networking system.

17. The method of claim 14 wherein the one or more first development support elements include at least one of a software application, a physical product, a service, a digital asset, and a personal contact.

18. The method of claim 15 wherein the one or more second development support elements include at least one of a software application, a physical product, a service, a digital asset, and a personal contact.

19. The method of claim 14 wherein the providing to the first user the one or more first developmental support elements in (D) includes providing at least a portion of the one or more first developmental support elements via a first graphical user interface.

20. The method of claim 14 wherein the first user action includes at least one of reading a document, viewing a video, listening to audio, taking a class, using a software application, making a contact, partnering with a second user, and meeting with an entity.
